(19) United States
(12) Patent Application Publication
(10) Pub. No.: US 2021/0299947 A1
(43) Pub. Date: Sep. 30, 2021

(54) METHOD FOR MANUFACTURING A PART

(71) Applicant: AIRBUS OPERATIONS SL, Madrid (ES)

(72) Inventors: Asuncion BUTRAGUENO-MARTINEZ, Madrid (ES); Guillermo HERNAIZ LOPEZ, Madrid (ES); Jose SANCHEZ-GOMEZ, Madrid (ES)

(21) Appl. No.: 17/212,592

(22) Filed: Mar. 25, 2021

(30) Foreign Application Priority Data
Mar. 25, 2020 (EP) 20382229-1

(51) Int. Cl. B29C 64/118; B33Y 10/00; B33Y 70/00

(52) U.S. Cl. CPC B29C 64/118; B29K 2105/124; B33Y 70/00; B33Y 10/00

(57) ABSTRACT

A method for manufacturing a part layer-upon-layer using Additive Manufacturing technology suitable for structural applications. The method includes selectively depositing at least a first type filament and a second type filament, wherein the second type filament differs from the first type filament at least in the cross-sectional dimension.

### RELATED APPLICATION

This application claims priority to European Patent Application 20382229-1, filed Mar. 25, 2020, the entirety of which is incorporated by reference.

### TECHNICAL FIELD

The present invention belongs to the field of manufacturing, in particular to the field of manufacturing parts with low or no porosity by using an Additive Manufacturing technology.

More specifically, the invention is of special application in the manufacturing of printed parts for structural applications where conventional compaction is not feasible.

### BACKGROUND OF THE INVENTION

Historically, aircraft parts with structural applications have been made of aluminum alloys. In recent decades, with the development of composite manufacturing technologies, such structural parts have been manufactured with different techniques such as, co-bonding or co-curing of Carbon Fiber Reinforced Plastic (CFRP) constituent parts.

Nevertheless, all these manufacturing technologies require that the components roll over different stages carrying operations to manufacture separately different constituent parts, which would be afterwards assembled together. This constitutes a time-demanding process predetermining the production rate of aircrafts. As a consequence, the final component is achieved after a series of different manufacturing steps that increment the cost and time of fabrication.

This drawback, along with the high recurring/non-recurring costs associated to these conventional manufacturing techniques, has promoted the advent of Additive Manufacturing (AM) technologies in aeronautics.

AM technologies typically use a computer with 3D modelling software (Computer Aided Design or CAD), an additive manufacturing tool (e.g. computer controlled printing machine equipment) and filaments used as a layering material. The 3D modelling software is used to generate a CAD sketch, e.g., CAD File, including a 3D electronic model of the final 3D object to be built. The AM tool is to reads the data from the CAD file (both the cross-section geometry and surface pattern) and controls a print head(s) to print, e.g., lay down or deposit, successive layers of filaments of liquid, powder, sheet material or the like, by at least one head in a layer-upon-layer fashion to fabricate a 3D object.

AM technologies allow for reducing the buy-to-fly ratio (i.e. the ratio between mass of material that is required to produce a part and the mass of material in the finished aeronautical structure) and enabling rapid prototyping by printing polymeric parts for aircraft.

Nevertheless, the mechanical properties of printed composite parts for aircraft tend to be inferior to the properties of the same parts made from aluminum or composite materials manufactured by conventional techniques (non-AM). AM printed parts tend to have defects, such as voids, porosity and poor adhesion between the printed filaments in the same layer or in adjacent layers.

In AM printed parts the porosity or process-induced voids form mainly as a result of stacking layers of substantially circular cross-section filaments. The voids tend to extend along a printing direction. Another typical local defect in an AM printed part is an absence of polymer chain interfusion between adjacent filaments which results in a low inter-laminar shear strength (‘ILSS’) that weakens the printed parts and makes the parts susceptible to failure when subjected to certain stresses.

When AM printed parts are tested or put into service, the voids and printing defects in the parts may act as stress concentrators causing the parts to fail prematurely.

Current solutions mostly provide in situ compaction mechanisms based on a roller that applies pressure to deposited layers against the printing bed to close voids and strengthen bonding between layers. More recent solutions rely on vacuum beds to assist the printing process but, although consolidated pieces may be obtained, tight dimensions are not achievable with vacuum beds.

It is not always possible to benefit from these available compaction solutions because complex geometries being printed prevent uniform rolling of the part and because some printing tools are not compatible with the conventional compaction equipment.

Therefore, there is a need in the industry for an easy and effective fabrication of structural printed parts that can assure imparting mechanical properties so as to meet structural requirements and further can be extensively applied regardless the use of compaction systems and for any intended geometry.

### SUMMARY OF THE INVENTION

The present invention solves the aforementioned problems by providing a method for manufacturing a part layer-upon-layer using

The invention may be embodied as a method for manufacturing a part by printing filaments layer-upon-layer using an Additive Manufacturing technology, wherein the method comprises selectively depositing at least a first type filament and a second type filament.

Throughout this entire document, “Additive Manufacturing technologies” (AM) will be understood as technologies that build 3D objects by adding layer-upon-layer material, such as filaments. The material may be a meltable material or a matrix material such as in the case of reinforced materials. The material may change phase to a liquid in a print head upon the application of heat and, after being printed, the material solidifies, e.g., hardens, due to cooling.

Before printing, a digital CAD sketch of the 3D part is digitally sliced into multiple horizontal sections or layers. The printer controller uses the generated slices to control the printing of the filaments one layer at a time to form the part. The printed layers adhering to each other as one layer is printed onto another.

Many technologies are encompassed within Additive Manufacturing technologies, and include technologies that use various filament materials and various printing machine technology. Examples of printing machines include Selective Laser Sintering (SLS), Stereolithography (SLA), Multi-Jet Modelling (MJM), and Fused Filament Fabrication (FFF).

The Fused Filament Fabrication (FFF) is a process oriented fabrication which involves the use of materials in the form of filaments injected through at least one indexing nozzle onto a build sheet. The nozzle(s) trace(s) the surface pattern for each layer. The filament material printed in a one layer hardens prior to the deposition of the next layer onto the previously printed layer. The process repeats printing layers until the part is completed, i.e. is printed.

The method of the invention may embody printing the part using Fused Filament Fabrication (FFF). In FFF, each deposited layer is formed by a set of oriented filaments. FFF is a particular example of 3D-Printing (3DP).

The second type filament may differ from the first type filament at least with respect to the cross-sectional dimensions of the first and second types of filaments.

If the printer tools allows for the setting of a printed layer height, the cross-sectional dimension of the first or second type filament corresponds to the height setting that establishes the height of each layer formed by filaments. Setting a thicker layer height entails that the printed part will have a coarser (i.e. less fine) detail rendering the layers more visible. On the other hand, setting a thinner layer height allows a higher level of detail on the part but hinders production time.

If a filament (either first or second type) has a non-constant cross-sectional shape, the cross-sectional dimension shall be understood as the cross-sectional area or the value measured at the thickest point of such filament.

The inventive method comprises performing at least once the steps of: (a) forming a layer by depositing first type filaments, at least a portion of the first type filaments being deposited alongside each other thus creating at least one channel, and (b) depositing at least a portion of a second type filament along said channel.

The computer slicing the model of the part, e.g., the slicer program of the printing tool, may slice the part to provide non-uniform slicing of the 3D CAD part since the layers now have different heights by alternating layers formed by first type filaments or second type filaments at least for a portion of the part. In other words, alternating steps a) and b).

Therefore, a “layer” is understood as a set of filaments deposited during the same depositing step. A layer may comprise filaments deposited alongside each other and/or spaced apart filaments. Layers of first type filaments have at least some filaments deposited alongside each other, while layers of second type filaments may be formed by spaced apart filaments. For instance, in 2.5D fabrication, each filament comprised in the same layer is at the same height from the mold.

A pair of first type filaments deposited alongside each other for a certain length produces an intermediate recess, notch or channel that extends along them for such length.

A second type filament with a different cross-sectional dimension may be deposited over such channel thus touching simultaneously both previously deposited first type filaments.

Therefore, unlike prior art manufacturing processes where subsequent layer deposition of first type filaments induces interstitial voids, the present invention fills or occupies such voids with second type filaments.

Conventional manufacturing processes typically involve that a first type filament be deposited over a channel created by two filaments of the same type deposited alongside each other, or similarly that a pair of first type filaments be deposited over two filaments of the same type deposited alongside each other.

As the part is made of polymeric materials, fused filaments are driven out the nozzles thus tending to flatten upon deposition. Then, fused second type filaments may adapt better to the channel shape created by the pair of harden first type filaments in order to further mitigate porosity. In other words, the part manufactured by the present invention is closer to a homologous bulk part.

The avoidance or reduction of voids causes filaments to touch along more areas which, in combination with the fact that printing processes are typically performed under heat, promotes filament bonding and polymer interfusion thus improving inter-layer mutual adhesion.

As a result, not only mechanic properties such as ILSS, tensile strength, compression strength, etc. of the printed parts are highly improved but also dimensional tolerances.

Balancing the deposition of first or second type filaments does not jeopardize manufacturing lead time since no fine slicing is needed for the whole part. Therefore, the present invention speeds up time in comparison with fine printing.

In short, the consolidated printed parts manufactured by the method according to the invention have, in comparison with conventionally printed parts, high-resolution surfaces, less porosity or voids, and no interfaces.

For instance, aeronautical parts conventionally made in pieces and then assembled together (thus having interfaces) can be manufactured, according to the present invention, integrally in one-shot meeting any structural specification. This results in parts with no interfaces (i.e. are integral or self-sealed). Since thermoplastic printing materials exhibit a hygroscopic tendency, the resulting tightness advantageously reduces water ingestion issues and de-bonding. Also, there may be an operation enhancement as the printed part has a better structural behaviour.

The undesired effect of water ingestion is stressed in aeronautics, where structural parts are exposed in service to a humid environment.

Thus, the printed part may be an aeronautical part.

The first type of filament may comprise a greater cross-sectional dimension than the second type filament.

In a particular embodiment, at least one first type filament and/or at least one second type filament has a circular, triangular, or ellipsoidal cross-sectional shape.

In a particular embodiment, the first type filament is deposited at a first temperature while the second type filament is deposited at a second temperature.

Print heads typically comprise an extruder which uses torque and pinch systems to feed and retract the filaments fed, to drive the required amount of material to be deposited. The print head may also comprise a heater block for heating the meltable material up to any precise temperature. Once the material is heated, it is forced out of a nozzle by a reduction in its diameter letting the material to be deposited more accurately.

Therefore, according to this embodiment, two print heads may be used, one for each filament type, in order to drive the filament out at a different temperature. Alternatively, with a single head, the heater block selectively heats the first or second type filaments to their respective precise temperatures.

At least the second temperature at which the second type filament is to be deposited may be above the glass-transition temperature of the second type filament to adapt better to the channel shape upon being laid down.

In addition, as it was already mentioned, when a single or a pair of first type filament(s) is/are deposited over a channel created by two filaments of the same type deposited alongside each other, a process-induced void is created, either a substantially triangular void or a substantially kite-shape void, respectively.

Thus, in a particular embodiment, at least a portion of a second type filament is deposited along (and over) a first type filament so that to infill a channel to be created by a subsequent pair of first type filaments deposited alongside each other.

Therefore, in a particular embodiment, the cross-sectional dimension and/or length of the second type filament is selected so as to infill such void such that there is no shortage or excess of infilling material, e.g., the second type of filament, in the voids.

In this regard, because of the strong dependence on the temperature when forming a bond between adjacent filaments/layers (diffusion-based fusion), typical printing tools pre-heat their printing chambers or the surroundings in order to reach and maintain an operating printing temperature determined by the materials chosen.

The method may be performed at a suitable operating printing temperature for the material of the first type and/or second type filament.

The operating temperature may be the glass transition temperature of the printed part material in order to soften the deposited filaments and slightly enable shaping. If the first and second type filaments are of different materials, the operating temperature will be the lowest glass transition temperature between both materials.

For instance, typical values of glass transition temperature are approx. 143° C. for PEEK (Polyetherketoneketone), 50° C. for PA66 (e.g. nylon), and 105° C. for ABS (Acrylonitrile butadiene styrene). Although the precise value of glass transition temperature depends on the measuring technique, all the known results provide values similar enough as to apply the present invention.

In addition, since printing speed sets the residence time of fused filament over a prior filament already hardening, it may affect convection heat transfer between filaments/layers. Nevertheless, for the purposes envisaged with this invention, it has been found that printing speed has a minimum effect on final properties insofar regular values are used.

Then, the cooling down (normally defined in terms of ° C./min) of the printed part from the operating temperature leads to its solidification and, therefore, has an impact on its final mechanical features as the material shrinks and internal stresses start to appear. If cooling speed is slow enough, residual thermal stresses on the printed part are mostly avoided.

Accordingly, in a particular embodiment, the method further comprises the step of cooling down the part at a predefined cooling speed. This cooling rate may be selected for such part to achieve a certain degree of crystallization, such as at least 32%.

In a particular embodiment, the first type filaments and/or the second type filament is made of fibrous material reinforcement embedded within meltable material.

By depositing fibrous material reinforcement with meltable material, a lightweight design is achieved because less amount of material is needed to meet the structural requirement compared to using solely meltable material.

According to the invention, the fibrous material reinforcement may be in the form of fibrils (very short and/or irregular fibers), nanofibers, carbon fillers, short fibers (length<1 mm), or continuous fibers (extended continuously along the whole filament and thus along the whole length/width of the part when manufactured), for instance. The fibrous material reinforcement may be in the form of continuous fibers and/or short-fibers.

Additionally, the fibrous material reinforcement may be glass, carbon, polymer fibers or any other conventional material used as reinforcement.

The meltable filament material may be a thermoplastic material such as PA (Polyamide), PPS (Polyphenylene sulfide), PA66, ABS (Acrylonitrile butadiene styrene), PEEK (Polyether ether ketone), PAEK (Polyaryletherketone) or PEKK (Polyetherketoneketone). The meltable filament material may be in the form of a filament for better storing and handling. The meltable filament material may be a thermoplastic material of any of the following: PEKK, PPS, PAEK, or PEEK. The first type filaments may have a fiber volume content above 50%, and the second type filaments may have a fiber volume content below 50%.

A fiber volume in the filament material of the first and/or second type may be a fiber content of at least 50% to enhance the mechanical properties of the final part as it improves the stiffness/weight ratio of the part. The fact that the second filament has less fiber volume content makes it easier to fill gaps but without drastically reducing the mechanical properties of the final part.

In a particular embodiment, at least one of the second type filaments is discontinuous in form of pellets or spheres.

The second type filaments may be in the form of pellets or spheres that are homogeneously deposited over the channel.

If the second type filament is fibrous material reinforcement embedded within meltable material in the form of pellets or spheres, this fibrous material reinforcement may be in the form of fibrils, nanofibers, carbon fillers, or short fibers.

Furthermore, some layers may be formed by second type filaments only with meltable material, others with fibrous material reinforcement embedded within meltable material, or a combination thereof.

Similarly, some layers may be formed by continuous second type filaments and others with second type filaments in the form of pellets or spheres, or a combination thereof.

The manufactured part may be formed entirely by alternating layers made from the first type filaments and second type filaments. That is, steps a) and b) are repeated up to manufacturing the entire part.

On the other hand, only a portion of the part can be printed by alternating these two layers (for instance performing steps a) and b) only a number of times onto a partially manufactured part). Therefore, these alternating layers are deposited to better suit future load requirements during operation and service. Therefore, an optimized structural arrangement is achieved while saving printing time.

For instance, any structural part designed with an overloaded section or which has a crucial section typically oversized by a safety factor may benefit from the present invention by alternating these layers of two different filament types within this susceptible section.

To further improve tightness or reduce water ingestion issues and de-bonding, in a particular embodiment, the method may further include depositing at least a portion of a second type filament along channels formed by filaments with first cross-sectional dimension forming part of an outer wall of the part.

In this embodiment, in addition, the outer wall of the part can be made entirely by layer(s) of second type filaments in order to further improve dimensional tolerances.

It is to be noted that, in this embodiment, “layers” of second type filaments also encompasses a non-stratified bunch of second type filaments.

Advantageously, this allows that layers of first type filaments be oriented according to expected loads while further layer(s) of second type filaments are provided so as to offset theoretical dimensions of the part. In other words, strength requirements are untied from dimensional tolerances.

In an embodiment, a third or further type filaments can be selectively deposited together with the first type filament and a second type filament. Accordingly, it renders the method more versatile in regard of applications.

This third or any further type filament has at least a different cross-sectional dimension than the first and second type filaments and can benefit from any of the features defined in relation to the second type filament such as the discontinuity or cross-sectional section.

In a second inventive aspect, the invention provides a part manufacturable layer-upon-layer using Additive Manufacturing technology according to any of the embodiments of the first inventive aspect. The part may be an aeronautical part.

All the features described in this specification (including the claims, description and drawings) and/or all the steps of the described method can be combined in any combination, with the exception of combinations of such mutually exclusive features and/or steps.

### DESCRIPTION OF THE DRAWINGS

These and other characteristics and advantages of the invention will become clearly understood in view of the detailed description of the invention which becomes apparent from an embodiment(s) of the invention, given just as an example and not being limited thereto, with reference to the drawings.

FIG. 1 shows layers made by first type filaments deposited alongside each other with process-induced triangular voids.

FIG. 2 shows layers made by first type filaments deposited alongside each other with process-induced kite-shaped voids.

FIGS. 3a and 3b show a cross-sectional view of (FIG. 3a) two layers each formed by depositing first and second type filaments, and (FIG. 3b) shows the same layers as in FIG. 3a but with the second type filaments being deposited as a melted, e.g., liquid, filament that filling the channels and thereby avoids the formation of voids.

FIG. 4 shows layers made by first and second type filaments wherein the second type of filaments are deposited in an offset external dimension as compared to the first type of filaments.

### DETAILED DESCRIPTION

The person skilled in the art should recognize that aspects described herein can be embodied either as a method for manufacturing a part, or as the part itself.

A method for manufacturing a part layer-upon-layer using Additive Manufacturing technology has been invented and disclosed herein. The method includes performing at least once the steps of: (a) forming a layer by depositing first type filaments, at least a portion of the first type filaments (1) being deposited alongside each other thus creating at least one channel (3), and (b) depositing at least a portion of a second type filament (2) along, e.g., in, said channel (3), wherein the second type filament (2) differs from the first type filament (1) at least in the cross-sectional dimension.

The method may use an additive manufacturing tool comprising a printing chamber housing a build sheet and at least one print head configured to move over the build sheet and to deposit selectively the first type of filament(s) (1) and the second type of filament(s) (2).

The print head may be equipped with different nozzles interchangeable during the printing process or a single nozzle with variable geometry and/or dimension. As mentioned, the print head(s) may also comprise a heater block for heating the meltable filaments (1, 2) to temperature, such as to melt the filament prior to be deposited to form a part.

The print tool may further comprise spool(s) for storing the filaments (1, 2).

In an embodiment, the print head is configured to be moved over the build sheet in the three-translational axes (X, Y, Z) and/or rotations (around X, Y, Z) for printing more complex geometries. Optionally, the print head(s) may be limited to move over the build sheet just in horizontal directions (X, Y) while the movement in vertical Z-direction is performed by the build sheet, thus implementing 2.5D fabrication. These movements may be performed by actuators and/or servos, one for each direction and/or rotations.

FIG. 1 depicts layers made by first type filaments (1) deposited alongside each other and having created triangular voids (3.1). This process-induced triangular voids (3.1) occurs when a single first type filament (1) is deposited over a channel (3) created by two filaments (1) of the same type deposited alongside each other.

A channel (3) is created when two filaments (1) of the same type, e.g., first type, are deposited alongside each other, while the process-induced void (3.1) requires further filament(s) (1) to be disposed above them, i.e. a closed perimeter. Thus, the channel (3) becomes a void (3.1) when a layer of filaments is deposited over the side-by-side portions of the first type of filaments in the lower layer shown in FIG. 1. The formation of voids can be avoided using the method disclosed herein.

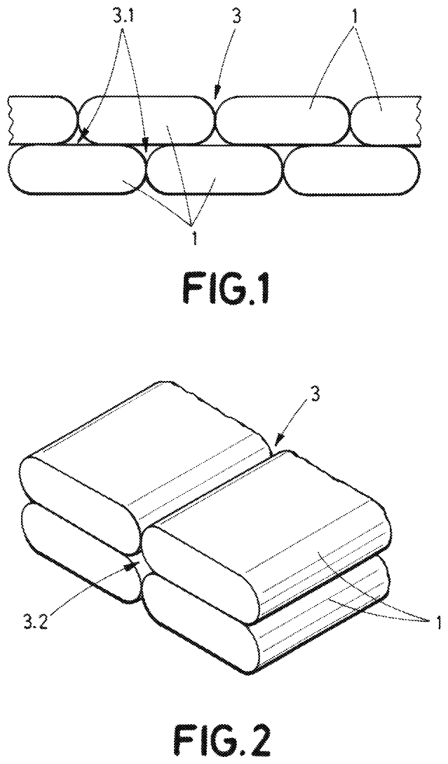

FIG. 2 depicts layers made by first type filaments (1) deposited alongside each other and having created kite-shaped voids (3.2).

Kite-shaped, e.g., rhombus, voids (3.2) occur when portions of first type filaments (1) are deposited over a channel (3) created by filaments (1) of the same type in a previously deposited layer.

FIGS. 1 and 2 depict the deposited first type filaments (1) flattened due to gravitational and temperature-related mechanisms that take place during cooling and hardening.

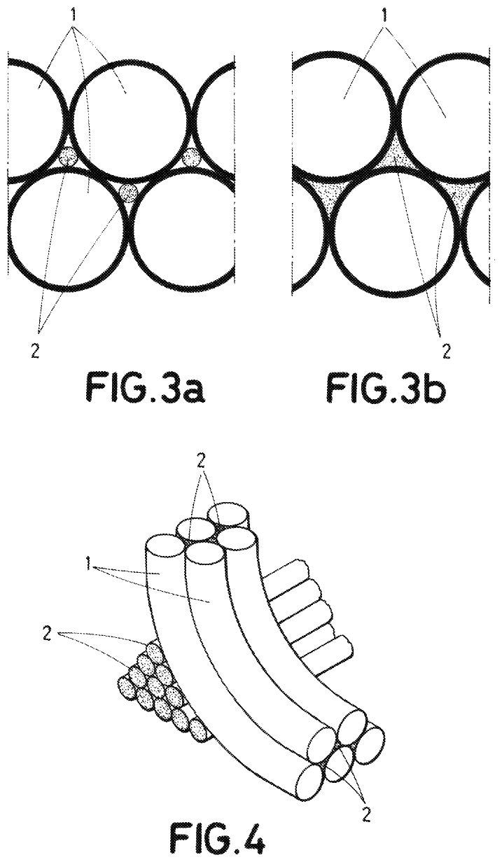

FIG. 3a depicts a cross-sectional view of a hypothetical situation where layers made by first type filaments (1) are alternated with layers made of second type filaments (2) but without having being fused yet.

It can be observed that, in this example, both the first type filaments (1) and the second type filaments (2) have a circular cross-sectional shape. Nevertheless other cross-sectional shapes can be selected or combined to maximize infill.

As visible in FIG. 3a, a second type filament (2) has been deposited along a channel (3) formed by a pair of first type filaments (1) deposited alongside each other underneath. Additionally, two second type filaments are shown, which have been deposited on two respective first type filaments, along them, so as to infill a channel to be created by a subsequent pair of first type filaments deposited over it alongside each other.

The first type filaments (1) may have a greater cross-sectional dimension than the second type filaments (2), such that the cross-sectional dimension, e.g., diameter, of the first type of filament is several times, e.g., twice, triple, five times or ten times, the cross-sectional dimension, e.g., diameter, of the second type of filament. The cross-sectional dimension of the second type filaments by be chosen to infill the channel and fill any voids (3.1, 3.2) that would have been formed but for the second type of filament. The cross-sectional dimension of the second type of filament may be selected to infill the channel and void, wherein the selection accounts for thermal expansion and/or shrinkage of the first and second type of filaments (1, 2) during the fusing and hardening of the filaments.

FIG. 3b shows the second type filaments (2) infill what would have been voids between two layers of the first type of filaments.

A third or further types filaments may be selectively deposited together with the first type filament and the second type filament to achieve the desired infilling of channels and voids.

FIG. 4 depicts a first layer of a first type filaments (1) which will be adjacent a second layer also of the first type of filaments. Between the two layers is a second type filaments (2) which fills a channel between the two layers of the first type of filament. The layers of the first type of filaments are oriented in a first direction/plane perpendicular to a second direction of the second type of filaments. Thus, the layers made by the second type filaments (2) are oriented to be offset the external dimensions of the layers formed by the first type of filaments.

The channel formed by layers of the first type of filaments may be at an outer surface of a part. The channel is infilled by depositing the second type of filaments along a direction at an angle to, e.g., perpendicular, to the direction of the first type of filaments. The outer surface, e.g., outer wall, is formed by the first and second types of filaments.

The second type filaments (2) may be oriented in a second direction to facilitate the printing process and to be used as support material for the layer(s) formed by the first type of filaments. Layers of first type filaments (1) may be oriented according to directions of expected loads applied to the part to achieve good structural properties of the part. The layer(s) of the second type filaments (2) may be deposited along directions which allow the second type of filaments to fill channels and need not be along directions to provide structural support for the part. As a result, the strength requirements of a part can be satisfied by the first type of filaments and the dimensional tolerances of the part can be satisfied with both the first and second types of filaments.

In addition, the method may comprise a step of depositing at least a portion of a second type filament (2) along channels (3) formed by first type filaments (1) forming part of an outer wall of the part. Thus, the second type of filament (2) forms part of the outer wall with the first type of filament (1). This embodiment may be of application, for instance, for producing a local roving or fill and thus create any required area to get the final shape of the part allowing the production of more complex shapes.

In aeronautical parts, especially for ‘T-profile’ composite parts such as stringers, a roving is a composite filler adapted to fill the space between both feet (i.e. the diverting point of both halves of the ‘T-profile’ composite part). Therefore, a ‘roving’ will be understood as a bundle of second type filaments which may be unidirectional and unspun or otherwise shaped into patterns to provide structural continuity and void avoidance.

Furthermore, if the outer wall of the part is made entirely by layer(s) of second type filaments (2), not only dimensional tolerances are improved but the resulting tightness prevents water ingestion and de-bonding.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a part layer-upon-layer using an additive manufacturing technology, wherein the method comprises:
depositing a first type of filament, wherein at least a first portion of the first type of filament is deposited adjacent a second portion of the first type of filament such that a channel is formed between the first and second portions, and
depositing at least a portion of a second type filament in or along the channel;
wherein the second type of filament differs in least a cross-sectional dimension from the first type of filament.

2. The method for manufacturing according to claim 1, wherein the first type of filament is larger in cross section than the second type filament.

3. The method for manufacturing according to claim 1, wherein at least one of the first type filament and the second type filament has shape in cross section that is a circular, triangular or ellipsoidal.

4. The method for manufacturing according to claim 1, wherein at least one of the first type of filament and the second type of filament is a fibrous material reinforcement embedded within a meltable material or thermoplastic material.

5. The method for manufacturing according to claim 1, wherein the second type of filament is deposited as pellets or spheres.

6. The method for manufacturing according to claim 1, wherein the second type of fibrous material is formed of fibrils, nanofibers, carbon fillers and short fibers.

7. The method for manufacturing according to claim 1, wherein the first type filament has a fiber volume content of at least 50%, and the second type filament has a fiber volume content below 50%.

8. The method for manufacturing according to claim 1, wherein at least a portion of the second type filament is deposited alongside the first portion of the first type filament, and the channel is formed depositing the second portion of the first type of filament after the second type of filament is deposited.

9. The method for manufacturing according to claim 1, wherein a cross-sectional dimension and/or length of the second type filament is sufficient to infill the channel.

10. The method for manufacturing according to claim 1, wherein the first type filament is deposited at a first temperature while the second type filament is deposited at a second temperature different from the first temperature.

11. The method for manufacturing according to claim 10, wherein the method further comprises cooling the part at a predefined cooling rate.

12. The method of claim 11, wherein the predefined cooling rate achieves a degree of crystallization of at least 32% in the part.

13. The method for manufacturing according to claim 1, wherein a portion of the part is manufactured by repeatedly alternating the performance of the forming and the depositing steps.

14. The method for manufacturing according to claim 1, further comprising depositing at least a portion of the second type filament along the channel formed by the first type filaments to form part of an outer wall of the part.

15. The method for manufacturing according to claim 14, wherein the outer wall of the part is formed entirely by at least one layer of the second type filament.

16. A method to form a party by additive manufacturing comprising:
depositing a first type of filament by additive manufacturing to form a first layer, wherein a channel is formed between a first portion of the first type of filament and a second portion of the first type of filament which is adjacent the first portion; and
at least partially filling the channel by depositing a second type of filament, wherein the second type of filament has a cross-sectional dimension which is smaller by at least a factor of two to a corresponding cross-sectional dimension of the first type of filament.

17. The method of claim 16, wherein the second type of filament is deposited parallel to the first type of filament.

18. The method of claim 16, wherein the second type of filament is deposited after the deposition of the first portion of the first filament and before the deposition of the second portion of the first type of filament.

19. The method of claim 16, wherein the first portion of the first type of filament is in a layer different than a layer of the second portion of the first type of filament.

20. The method of claim 19, wherein the second type of filament is deposited along a direction offset from a direction of the layers of the first type of filaments.
